(19) United States
(12) Patent Application Publication
(10) Pub. No.: US 2026/0269662 A1
(43) Pub. Date: Sep. 10, 2026

(54) STATOR FOR AN ELECTRIC MACHINE

(71) Applicant: ADDITIVE I DRIVES GMBH, Dresden (DE)

(72) Inventor: Axel HELM, Bannewitz (DE)

(21) Appl. No.: 18/871,804

(22) PCT Filed: Jul. 21, 2023
(86) PCT No.: PCT/EP2023/070282

§ 371 Date: Dec. 4, 2024

(30) Foreign Application Priority Data
Jul. 22, 2022 (WO) PCT/EP2022/070637
Dec. 5, 2022 (DE) 102022132247.5
Jan. 27, 2023 (DE) 102023102021.8
Feb. 27, 2023 (DE) 102023104731.0
Mar. 14, 2023 (DE) 102023106380.4

(51) Int. Cl. H02K 1/16; H02K 3/02; H02K 3/14

(52) U.S. Cl. CPC H02K 1/16; H02K 3/02; H02K 3/14

(57) ABSTRACT

Disclosed is a stator for an electric machine, for example for an electric motor or generator having a stator core which has a plurality of stator grooves. Electrical conductors forming a winding are arranged in the stator grooves. At least one part of the stator, for example a winding head connecting the electrical conductors, is realized by an additive manufacturing process, and the electrical conductors are inserted into respective stator grooves in a cross-section of the stator in the radial direction and extend in the longitudinal direction. A special sequence of the arrangement and a selection of types of electrical conductor are provided in the direction from an inner region oriented towards the stator longitudinal axis to an outer region.

The invention relates to a stator for an electric machine, in particular for an electric motor or generator having a stator core. The stator core preferably has a plurality of stator grooves, wherein electrical conductors forming a winding are arranged in the stator grooves and at least one part of the stator, in particular a winding head connecting the electrical conductor, is realized by means of an additive manufacturing process. The electrical conductors are preferably inserted into a respective stator groove in a cross-section of the stator in the radial direction and extend in the longitudinal direction.

DE 10 2021 119 405 A1 discloses a stator for an electric machine, a stator cooling system and a method for cooling a stator.

A stator core has at least one stator groove in which at least two, preferably at least four, electrical conductors are arranged, wherein at least part of the stator is manufactured using an additive manufacturing process. In particularly powerful motors, relatively high electrical currents flow in the conductors of the electric motor. As a result, heat is generated and the efficiency of the machine decreases due to the specific resistance of the conductor material and, for example, the skin effect or proximity effects during AC operation.

In the field of high-performance motors, for example when used in the drivetrains of electric vehicles, it is therefore necessary to ensure suitable stator cooling.

A known approach to cooling is to surround the electrical conductors of the stator with a heat conducting body. A further possibility is created by means of the additive manufacturing process, wherein at least one cooling channel to which a cooling fluid can be applied is formed for a predetermined number of electrical conductors, wherein at least two or at least four cooling channels, which are not formed by the same electrical conductor, are fluidically connected in parallel.

The electrical conductors according to DE 10 2021 119 405 A1 can be designed as individual winding conductors of a winding, preferably as individual winding conductors of a coil or so-called I-pins or as U-pins or hairpins. The electrical conductors of a stator groove are arranged in particular in a cross-section perpendicular to a central axis of the stator in a radial direction of the stator, wherein the electrical conductors arranged in an inner area in relation to the radial direction of the stator have the aforementioned cooling channels. This makes it possible to introduce cooling power directly where the heat development in the stator groove is greatest and to serve as a heat sink.

WO 2023/006612 A1 relates to a method for manufacturing a stator comprising a winding, preferably a hairpin winding for an electric machine, in particular an electric motor or a generator. The object is to reduce the thermal and also the electrical power loss in the stator and to reduce the installation space for the stator.

This involves introducing, in particular inserting winding bases into stator grooves and additively applying at least one section of a winding head, in particular by applying a build-up material in layers and locally selectively solidifying this build-up material by irradiation.

In this respect, the winding head has connecting elements that are manufactured using an additive process. The envelope and thus the installation space of the winding head can be reduced or minimized. This technology can reduce or avoid material changes and contact problems that would otherwise occur through welding. The winding base bodies can be varied in terms of their shape and/or their cross-sections and combined with the winding head in variable ways. In one embodiment there, the cross-sectional areas of individual winding bases are maximized for low frequencies. In this case, a stator groove can be divided into segments running side by side in the axial direction, wherein the corresponding winding base body fills the respective segment at least substantially completely. For high frequencies, the cross-section of one or each basic winding body can be divided into at least two or three partial cross-sections that are insulated from each other, in particular to reduce the current displacement inside the conductor caused by skin effects, for example, and thus reduce eddy current losses.

It is generally known that the current displacement in the groove of an electric machine, which is provided with the corresponding electrical conductors as part of a winding, varies.

This depends on the one hand on the operating mode of the corresponding machine and on the other hand on electrical-physical mechanisms such as the so-called skin effect, the proximity effect and also eddy currents. The current displacement increases with increasing frequency and increasing flux density. For high-performance machines, such losses must also be minimized and not only suppressed in their effects through cooling.

From the foregoing, it is therefore the object of the invention to provide a further developed stator for an electric machine, in particular a motor or a generator, which creates the conditions for achieving or ensuring energy-efficient operation of a correspondingly designed machine, in particular reducing the increase in winding losses and significantly reducing the thermal load on the electrical conductors used and their insulation.

Here, the applicant's knowledge of the formation of partial conductors twisted together over the active length to divide the cross-section in order to reduce the skin effect and prevent loop currents is used, as is the idea of shifting the twisting and layering of the partial conductors from the active area to the area of the winding head, which is made possible in particular by additive manufacturing technology. This measure allows the groove area, in particular the groove cross-section, to be optimally utilized and DC losses to be reduced.

The object of the invention is solved by a stator according to the combination of features according to claim 1, wherein the subclaims represent at least expedient designs and further developments.

A stator for an electric machine is therefore assumed. This is preferably a stator for an electric motor or an electric generator with a stator core. The stator core comprises a laminated core and a comparable design with a large number of stator grooves.

Electrical conductors forming a winding are arranged in the stator grooves. At least one part of the stator, in particular a winding head connecting the electrical conductors, is realized by means of an additive manufacturing process known per se. The electrical conductors are inserted into a respective stator groove in a cross-section of the stator in the radial direction and extend in the longitudinal direction. In all or in selected stator grooves, several types of electrical conductors are arranged (in the respective stator groove), preferably in such a way that (in the respective stator groove) a different type of electrical conductor is located in an inner area (in particular closer to the stator longitudinal axis) than in an outer area, so that, for example, a stranded wire is located in the inner area and a different type (Le. no stranded wire), e.g. solid metal, is located in the outer area.

Preferably, the order of arrangement and the selection of types of electrical conductors in all or in selected stator grooves is carried out in the direction from an inner area (oriented towards the longitudinal axis of the stator) to an outer area according to the expected current density for the respective electrical conductor located at a radial distance from the longitudinal axis of the stator. The current displacement changing in the radial direction is preferably taken into account here.

The above means in particular that in the radial direction in the respective grooves, not electrical conductors of basically the same design or of the same type, but specified types are used.

Preferably, one or more stranded conductors or twisted strands with a geometry that fills the groove in particular are arranged in or in the direction of the inner area oriented towards the stator longitudinal axis (or elsewhere, in particular in the stator groove).

In particular, following the stranded conductor(s) radially outwards (or elsewhere, in particular in the stator groove), there are preferably rotating segmented conductors and/or stacked strip conductors forming a layered arrangement. These are functionally comparable to a Roebel rod in particular,

Preferably, solid metal conductors, in particular profiled wire solid copper conductors, are located in the respective stator grooves, in particular radially on the outside (or elsewhere, in particular in the stator groove).

The stranded conductors can consist of different conductor types, in particular different materials.

In one design, the stranded conductors can have a sheath based on a solid conductor. This solid conductor or the solid conductor sheath can be realized by means of additive manufacturing (additive printing).

The rotating segmented conductors preferably consist of individual conductors with different cross-sections that are twisted together, wherein the wiring rearrangement of the individual conductors is realized in the winding head in particular in order to reduce DC losses.

At least some of the electrical conductors can be designed as so-called hairpins.

Alternatively or additionally, it is also possible to use Roebel conductors, which consist of several individual conductors that swap their positions once over the length of the conductor in the course of a full transposition length. This means that each conductor changes its position in a wound coll. This is particularly important with regard to minimizing alternating current losses and reducing coupling losses. A Roebel conductor usually has an extension of several (or very many) full transposition lengths and is able to carry high currents due to a very large number of individual conductors.

The aforementioned strip conductors offer advantages for AC-powered machines and comprise at least two elongated, rigid strip conductor elements with corresponding contact devices for coupling and decoupling electric current, wherein the strip conductor elements provide a current path and the strip conductor elements are designed as a layered arrangement with electrical insulation in between. Coupling and decoupling of electric current is carried out in particular via a winding head on one or both sides, depending on the type of design of the conductors in U or I shape.

The strip conductor elements used are preferably stacked on top of each other and exchange positions at least once over their conductor length in the course of a full transposition section with respect to their position in the stack. Preferably, the position exchange is realized without twisting and torsion by complementary step jumps of the strip conductor elements, preferably carried out by means of material forming.

The cross-sectional area shape of the strip conductor elements varies in the area of the step jumps. However, the cross-sectional area is preferably (largely) constant in the area of the step jumps with varying cross-sectional area shape.

The cross-sectional area in the region of the step jumps of the strip conductor elements is preferably adapted to the cross-sectional area of the other sections of the strip conductor elements.

In particular, the step jumps each have complementary recesses on the width side of the strip conductor elements, which interlock as a result of the joining of the stack.

The corresponding strip conductors preferably comprise a stacked arrangement of at least two strip conductor elements with at least two step jumps, wherein the respective ends of the strip conductor elements are electrically connected.

The dimensions of the stacking arrangement are adapted to the dimensions of the stator grooves of the electric machine in terms of length and cross-section. The strip conductors can be part of a rectangular coil and/or a hairpin.

The strip conductor elements are preferably stacked closely, without gaps, tightly and with a thin insulating layer in between and/or form a compact arrangement.

The thickness or layer thickness of the insulating layer is preferably (many times) smaller than the thickness of the actual strip conductor elements.

The strip conductor elements can consist of a copper or copper alloy material or solid material and/or be manufactured using additive technology. Aluminum material can also be used.

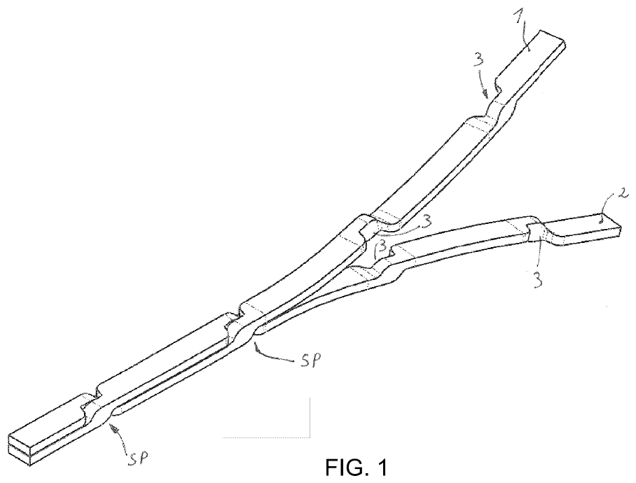

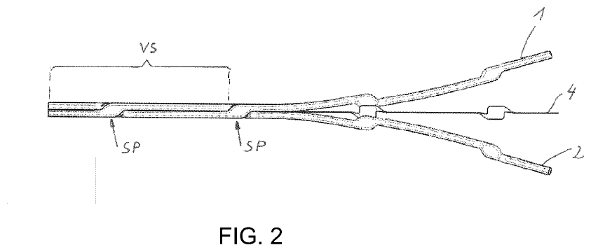

The strip conductor elements used according to the invention in stacked form, forming a layer arrangement, are to be explained in more detail according to an exemplary embodiment and FIGS. 1 and 2, wherein:

FIG. 1 shows a perspective view of a strip conductor device joined by bringing together two strip conductor elements according to the invention, which are already provided with an enveloping insulating layer, and

FIG. 2 shows a side view similar to that shown in FIG. 1, but with embedding of an insulating layer in the joining process of two strip conductor elements with step jumps to produce the strip conductor device.

The strip conductor device as shown in the figures comprises two strip conductor elements 1; 2, which are stacked on top of each other.

The strip conductor elements 1; 2 swap places in relation to their position in the stack over the course of a full transposition section VS.

In the example shown, the strip conductor element 1 is located at the top in the left-hand section shown in FIG. 1 and changes its position downwards via a step SP.

The reverse is true for the strip conductor section 2, which changes its position from the bottom via the step SP to the top as shown in the FIG. 1.

It can be seen from the figurative representation that the exchange of positions of the strip conductor elements is realized without twisting and torsion by complementary step jumps SP of the strip conductor elements, for example by means of material forming.

The cross-sectional surface shape of the strip conductor elements 1; 2 varies in the area of the step jumps SP.

By shaping in the area of the step jumps SP, it is possible to keep the cross-sectional area (largely) constant with varying cross-sectional area shape, so that current-related hotspots can be avoided.

It is in the spirit of the invention that the cross-sectional area in the area of the step jumps SP is essentially adapted to the cross-sectional area of the other sections of the strip conductor elements 1; 2 and, if possible, is designed to be the same.

The step jumps SP each have complementary recesses 3 on the width side of the strip conductor elements, which interlock as a result of the joining of the gap (see FIG. 1).

As a result of joining the strip conductor elements 1; 2, preferably with a mechanical device, a strip conductor device with two strip conductor elements 1; 2, which are stacked closely, gap-free and lightly over their entire surface, is produced, based on a view of FIG. 1 from right to left, so that a compact arrangement is created.

If uninsulated strip conductor elements 1; 2 are used, a thin insulating layer 4 is inserted between the strip conductor elements 1; 2 during the process of stacking the strip conductor elements 1; 2 on top of each other (see FIG. 2).

This insulating layer 4 can already be preformed with regard to the contour in the area of the step jumps SP or can also consist of a material that takes on the shape of the strip conductor elements 1; 2 in the area of the step jumps when they are brought together and joined.

The strip conductor elements 1; 2 can consist of a solid copper or copper alloy material, which is advantageous for more effective and cost-effective production. By means of known, preferably used material forming processes, solid strip materials with a preferably rectangular cross-section can be formed in such a way that the step jumps SP that are relevant here are formed and the joining of the strip conductor elements 1; 2 to obtain the strip conductor device can be carried out in a simple automated manner.

Due to the non-linear conductor structure with step jump, one advantage of the presented strip conductor device is a reduction in the area of attack for a transverse groove field when the strip conductor device is used in electric machines. Furthermore, the current displacement is minimized. By simply adapting the conductor geometry, it is possible to react to a different frequency spectrum when operating electric machines. Any increased current density in the area of the step jump can be reduced by geometric adaptation and optimization.

If one compares the copper losses as a function of the conductor geometry based on known twisted conductor structures with copper losses of the strip conductor device according to the invention, then the frequency-dependent increase in losses when using a strip conductor device with a stacked arrangement of strip conductor elements and step jump is significantly reduced, especially at higher frequencies between 600 and 1000 Hertz.

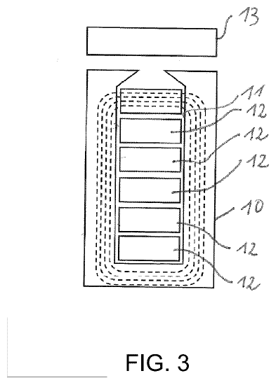

The formation of the order of arrangement and the selection of types of electrical conductors will be explained in more detail using the following exemplary embodiment in conjunction with FIG. 3 to 6, wherein:

FIG. 3 shows a partial cross-sectional view of a stator and an associated rotor section of an electric machine with an indicated groove diffusion field (dashed line) and various electrical conductors within a stator groove;

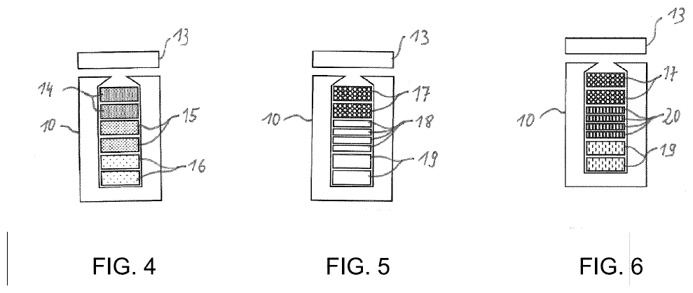

FIG. 4 shows an illustration of the different current density resulting from the current displacement in the groove of an electric machine with a region of very high current density in the direction of the rotor section and a moderate or lower current density in a region away from the rotor, i.e. in the outer direction;

FIG. 5 shows an exemplary embodiment of a selection of types of electrical conductors with the aim of a loss-reduced design of windings, wherein there are two layers of stranded conductors close to the rotor, i.e. inwards, followed by two layers of rotationally segmented conductors, again outwards, followed by two layers of solid conductors; and

FIG. 6 again shows a schematic cross-sectional view of an arrangement of electrical conductors from an inner area in the direction of the rotor to the outside with two layers of stranded conductors on the inside, followed by stacked strip conductors forming a layered arrangement and these in turn followed by electrical conductors in the form of solid conductors.

FIGS. 3 to 6 show part of the cross-section of a stator for an electric machine. An exemplary groove 11 is formed in this stator 10, which accommodates electrical conductors 12 that are part of a winding.

The course of the resulting groove scattering field is indicated by a dashed line. A part of a rotor 13 of an electric machine is symbolically indicated accordingly.

The resulting current density in the respective groove 11 is symbolized by the cross-sectional representation in FIG. 4. Close to the rotor 13, i.e. in the direction of an imaginary longitudinal axis of the stator, a high current density load 14 is to be expected. A moderate current density 15 is present in the middle area. In the outer area 16, the current density load is low to uncritical.

The current density distribution shown in FIG. 4 results from typical solid conductors with mutual insulation (indicated in the figures) and corresponding wiring in a winding head not shown. In accordance with the approach according to the invention, a special order of arrangement and a selection of types of electrical conductors in the stator grooves 11 is now carried out by way of example, as shown in the cross-sectional representation according to FIGS. 5 and 6. In the illustration according to FIGS. 5 and 6, stranded conductors 17 are first arranged in the area oriented towards the inside of the longitudinal axis of the stator (not shown).

These stranded conductors 17 are followed by a section with rotating segmented conductors 18, followed outwards by solid conductors 19. In the embodiment shown in FIG. 6, the stranded conductors, which have a groove-shaped geometry, are followed by strip conductors designed as stacked electrical conductors forming a layer arrangement 20.

These strip conductors are in turn followed by solid conductors 19.

The rotationally segmented conductors 18 are individual conductors twisted together with different cross-sectional sections, with the interconnection of the individual conductors preferably being realized in the winding head.

The strip conductors are conductors that consist of strip conductor elements stacked on top of each other and that change their positions at least once over their conductor length in the course of a full transposition section in relation to the position in the stack, wherein the position change is realized without twisting and torsion by complementary step jumps of the strip conductor elements, preferably carried out by means of material forming.

All the different conductor types mentioned above can be electrically contacted and connected without loss in the winding head using additive printing technology, without the need for welded or crimped connections.

At this point, it should be noted that all the parts described above are claimed to be essential to the invention when viewed individually and in any combination, in particular the details shown in the drawings. Modifications thereof are familiar to the person skilled in the art.

Furthermore, it is pointed out that the aim is to achieve the broadest possible scope of protection. In this respect, the disclosure contained in the claims can also be specified by features that are described with further features (even without these further features necessarily being included). It is explicitly pointed out that round brackets and the term “in particular” are intended to emphasize the optionality of features in the respective context (which does not mean, conversely, that a feature is to be regarded as mandatory in the corresponding context without such identification).

1. A stator for an electric machine, the stator comprising:
a plurality of stator grooves;
electrical conductors forming a winding and arranged in the stator grooves by inserting the electrical conductors into a respective stator groove in a cross-section of the stator in a radial direction and extending in the longitudinal direction,
wherein at least one part of the stator is realized by means of an additive manufacturing process
wherein the sequence of the arrangement and the selection of types of the electrical conductors in all or selected stator grooves in the direction from an inner area oriented towards the longitudinal axis of the stator to an outer area is carried out according to the current density to be expected for the respective electrical conductor located at a radial distance from the longitudinal axis of the stator, and the current displacement changing in the radial direction is taken into account in this case.

2. A stator according to claim 1, wherein that one or more stranded conductors with groove-filling geometry are inserted in the direction of the inner area oriented towards the longitudinal axis of the stator.

3. A stator according to claim 2, wherein the stranded conductor is followed in the radial direction outwards by rotating segmented conductors or stacked strip conductors forming a layer arrangement.

4. A stator according to claim 2, wherein solid metal conductors, are located radially on the outside in the respective stator grooves.

5. A stator according to claim 2, wherein the stranded conductors consist of different types of conductor material.

6. A stator according to claim 2, wherein the stranded conductors have a sheath based on a solid conductor.

7. A. stator according to claim 6, wherein the solid conductor sheath is formed by additive pressure.

8. A stator according to claim 3, wherein the rotationally segmented conductors consist of individual wires with different cross-sections twisted together, wherein the wiring rearrangement of the individual conductors is realized in the winding head.

9. A stator according to claim 1, wherein at least partial quantities of the electrical conductors are designed as hairpins.

10. A stator according to claim 3, wherein the strip conductors consist of elongated, rigid strip conductor elements, wherein the strip conductor elements are stacked on top of one another and exchange their positions at least once over their conductor length in the course of a full transposition section with respect to the position in the stack, furthermore the position exchange is realized without twisting and torsion by complementary step jumps of the strip conductor elements.

11. A stator according to claim 10, wherein the cross-sectional surface shape of the strip conductor elements varies in the area of the step jumps.

12. A stator according to claim 11, wherein the cross-sectional area is largely constant in the region of the step jumps with varying cross-sectional area shape.

13. A stator according to claim 12, wherein the cross-sectional area in the region of the step jumps is adapted to the cross-sectional area of the other sections of the strip conductor elements.

14. A stator according claim 10, wherein the step jumps each have complementary recesses on the width side of the strip conductor elements, which interlock as a result of the joining of the stack.

15. A stator according claim 10, wherein the stacking arrangement comprises at least two strip conductor elements with at least two step jumps, wherein the respective ends of the strip conductor elements are electrically connected.

16. A stator according to claim 15, wherein the stacking arrangement is adapted to the dimensions of grooves in the stator of the electric machine with regard to its dimensions in length and cross-section.

17. A stator according to claim 10. wherein the stacking arrangement is part of a rectangular coil or a hairpin.

18. A stator according to claim 10. wherein the strip conductor elements are stacked closely over a large area, without gaps, tightly and with a thin insulating layer arranged in between and form a compact arrangement.

19. A stator according to claim 18, wherein the thickness or the layer thickness of the insulating layer is smaller than the thickness of the strip conductor elements.

20. A stator according to claim 10. wherein the strip conductor elements consist of a solid copper or copper alloy material or are manufactured using additive technology.

21. A stator according to claim 1, wherein all the different conductor types are electrically contacted and interconnected in the winding head by additive printing technology, free of welded or crimped connections.
